(19) United States
(12) Patent Application Publication
(10) Pub. No.: US 2007/0016397 A1
(43) Pub. Date: Jan. 18, 2007

(54) Collocation translation using monolingual corpora

(75) Inventors: Yajuan Lu, Beijing (CN); Ming Zhou, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/183,455

(22) Filed: Jul. 18, 2005

(51) Int. Cl. G06F 17/28

(52) U.S. Cl. 704/2

(57) ABSTRACT

An approach for extracting collocation translations is presented. The approach includes constructing a collocation translation model using monolingual source and target language corpora. An expectation maximization algorithm is used to estimate the collocation translation model. The collocation translation model can be used later to extract a collocation translation dictionary. The collocation translation model and dictionary can be used later for further natural language processing, such as sentence translation.

### BACKGROUND OF THE INVENTION

A dependency triple is a lexically restricted word pair with a particular syntactic or dependency relation and has the general form: <w₁, r, w₂>, where w₁ and w₂ are words, and r is the dependency relation. For instance, a dependency triple such as <turn on, OBJ, light> is a verb-object dependency triple. There are many types of dependency relations between words found in a sentence, and hence, many types of dependency triples.

A collocation is a type of dependency triple where the individual words w₁ and w₂, often referred to as the “head” and “dependant”, respectively, meet or exceed a selected relatedness threshold. Common types of collocations include subject-verb, verb-object, noun-adjective, and verb-adverb collocations.

Although there can be great differences between a source and target language, strong correspondences can exist between some types of collocations in a particular source and target language. For example, Chinese and English are very different languages but nonetheless there exists a strong correspondence between subject-verb, verb-object, noun-adjective, and verb-adverb collocations. Strong correspondence in certain types of collocations often make it desirable to use collocation translations to translate phrases and sentences from the source to target language. In this way, collocation translations are important for machine translation, cross language information retrieval, second language learning, and other bilingual natural language processing applications.

Collocation translation errors often occur because collocations can have unpredictable or idiosyncratic translations. For example, suppose the Chinese verb “kan4” is considered the head of a Chinese verb-object collocation. The word “kan4” can be translated into English as “see,” “watch,” “look,” or “read” depending on the object or dependant with which “kan4” is collocated. For example, “kan4” can be collocated with the Chinese word “dian4ying3,” (which means film or movie in English) or “dian4shi4,” which generally means “television” in English. However, the Chinese collocations “kan4 dian4ying3” and “kan4 dian4shi4,” depending on the sentence, may be best translated into English as “see film,” and “watch television,” respectively. Thus, the word “kan4” is translated differently into English even though the collocations “kan4 dian4ying3,” and “kan4 dian4shi4,” have similar structure and semantics.

In another situation, “kan4” can be collocated with the word “shu1,” which usually means “book” in English. However, the collocation “kan4 shu1” in many sentences can be best translated simply as “read” in English, and hence, the object “book” is dropped altogether in the collocation translation.

It is noted that Chinese words are herein expressed in “Pinyin,” with tones expressed as digits following the romanized pronunciation. Pinyin is a commonly recognized system of Mandarin Chinese pronunciation.

Currently, collocation translation often relies on parallel or bilingual corpora of a source and target language. However, large aligned bilingual corpora are generally difficult to obtain and expensive to construct. In contrast, unaligned text of a single language can be obtained more readily.

The discussion above is merely provided for general background information and is not intended to be used as an aid in determining the scope of the claimed subject matter.

### SUMMARY OF THE INVENTION

An approach for constructing a collocation translation model using monolingual corpora is presented. The approach includes estimating a translation model using an expectation maximization algorithm. The translation model is then used to extract collocation translations from monolingual corpora. The translation model and extracted collocation translations can be used for sentence translation.

This Summary is provided to introduce a selection of concepts in a simplified form that are further described below in the Detailed Description. This Summary is not intended to identify key features or essential features of the claimed subject matter, nor is it intended to be used as an aide in determining the scope of the claimed subject matter.

### BRIEF DESCRIPTION OF THE DRAWINGS

FIG. 1 is a block diagram of one computing environment in which the present approach can be practiced.

FIG. 2 is an overview flow diagram illustrating broad aspects of the present approach.

FIG. 3 is a block diagram of a system for augmenting a lexical knowledge base with probability information useful for collocation translation.

FIG. 4 is a block diagram of a system for further augmenting the lexical knowledge base with extracted collocation translations.

FIG. 5 is a block diagram of a system for performing sentence translation using the augmented lexical knowledge base.

FIG. 6 is a flow diagram illustrating augmentation of the lexical knowledge base with probability information useful for collocation translation.

FIG. 7 is a flow diagram illustrating further augmentation of the lexical knowledge base with extracted collocation translations.

FIG. 8 is a flow diagram illustrating using the augmented lexical knowledge base for sentence translation.

### DETAILED DESCRIPTION OF ILLUSTRATIVE EMBODIMENTS

Automatic collocation translation is an important technique for natural language processing, including machine translation and cross-language information retrieval.

The present approach provides for augmenting a lexical knowledge base with probability information useful in translating collocations. Also provided are collocation translations that are extracted using the probability information. The probability information and extracted collocation translations can be used later for sentence translation.

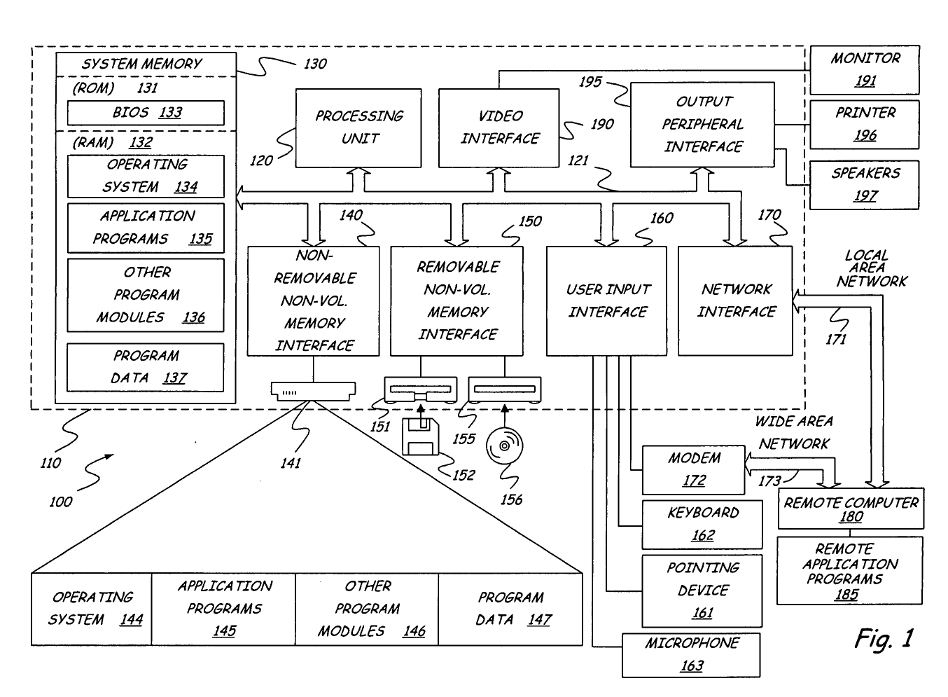

Before addressing further aspects of the present invention, it may be helpful to describe generally computing devices that can be used for practicing the invention. FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephone systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and figures provided herein as processor executable instructions, which can be written on any form of a computer readable medium.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

### Background Collocation Translation Models

Collocation translation models have been constructed according to Bayes's theorem. Given a source language (e.g. Chinese) collocation or triple cₜᵣᵢ=(c₁,r_{c},c₂) and the set of its candidate target language (e.g. English) triple translations eₜᵣᵢ=(e₁,rₑ,e₂), the best English triple êₜᵣᵢ=(ê₁,rₑ,ê2) is the one that maximizes the following equation.
Equation (1):

$$\begin{matrix}{\hat{e}}_{tri} = {arg max}_{{e}_{tri}} p ( {e}_{tri} \vert {c}_{tri} ) \\ = {arg max}_{{e}_{tri}} p ( {e}_{tri} ) p ( {c}_{tri} \vert {e}_{tri} ) / p ( {c}_{tri} ) \\ = {arg max}_{{e}_{tri}} p ( {e}_{tri} ) p ( {c}_{tri} \vert {e}_{tri} )\end{matrix} \qquad Eq . 1$$

where p(eₜᵣᵢ) has been called the language or target language model and p(cₜᵣᵢ|eₜᵣᵢ) has been called the translation or collocation translation model. It is noted that for convenience, collocation and triple are used interchangeably. In practice, collocations are often used rather than all dependency triples to limit size of training corpora.

The target language model p(eₜᵣᵢ) can be calculated with an English collocations or triples database. Smoothing such as by interpolation can be used to mitigate problems associated with data sparseness as described in further detail below.

The probability of a given English collocation or triple occurring in the corpus can be calculated as follows:

$$p ( {e}_{tri} ) = \frac{freq ( {e}_{1} , {r}_{e} , {e}_{2} )}{N} \qquad Eq . 2$$

where freq(e₁,rₑ,e₂) represents the frequency of triple eₜᵣᵢ and N represents the total counts of all the English triples in the training corpus.

For an English triple eₜᵣᵢ=(e₁,rₑ,e₂), if two words e₁ and e₂ are assumed to be conditionally independent given the relation rₑ, Equation (2) can be rewritten as follows:

$$p ( {e}_{tri} ) = p ( {r}_{e} ) p ( {e}_{1} \vert {r}_{e} ) p ( {e}_{2} \vert {r}_{e } ) \\ where \\ p ( {r}_{e} ) = \frac{freq (* , {r}_{e} , *)}{N} , \\ p ( {e}_{1} \vert {r}_{e} ) = \frac{freq ( {e}_{1} , {r}_{e} , *)}{freq (* , {r}_{e} , *)} , \\ p ( {e}_{2} \vert {r}_{e} ) = \frac{freq (* , {r}_{e} , {e}_{2} )}{freq (* , {r}_{e} , *)} . \qquad Eq . 3$$

The wildcard symbol * symbolizes any word or relation. With Equations (2) and (3), the interpolated language model is as follows:

$$p ( {e}_{tri} ) = α \frac{freq ( {e}_{tri} )}{N} + ( 1 - α ) p ( {r}_{e} ) p ( {e}_{1} \vert {r}_{e} ) p ( {e}_{2} \vert {r}_{e} ) \qquad Eq . 4$$

where 0<α<1. The smoothing factor α can be calculated as follows:

$$α = 1 - \frac{1}{1 + freq ( {e}_{tri} )} \qquad Eq . 5$$

The translation model p(cₜᵣᵢ|eₜᵣᵢ) of Equation 1 has been estimated using the following two assumptions.

Assumption 1: Given an English triple eₜᵣᵢ and the corresponding Chinese dependency. relation r_{c}, c₁ and c₂ are conditionally independent, which can be expressed as follows:

$$\begin{matrix}p ( {c}_{tri} \vert {e}_{tri} ) = p ( {c}_{1} , {r}_{c} , {c}_{2} \vert {e}_{tri} ) \\ = p ( {c}_{1} \vert {r}_{c} , {e}_{tri} ) p ( {c}_{2} \vert {r}_{c} , {e}_{tri} ) p ( {r}_{c} \vert {e}_{tri} )\end{matrix} \qquad Eq . 6$$

Assumption 2: For an English triple eₜᵣᵢ, assume that cᵢ only depends on eᵢ(iε{1,2}), and r_{c} only depends on rₑ. Equation (6) can then be rewritten as follows:

$$\begin{matrix}p ( {c}_{tri} \vert {e}_{tri} ) = p ( {c}_{1} \vert {r}_{c} , {e}_{tri} ) p ( {c}_{2} \vert {r}_{c} , {e}_{tri} ) p ( {r}_{e} \vert {e}_{tri} ) \\ = p ( {c}_{1} \vert {e}_{1} ) p ( {c}_{2} \vert {e}_{2} ) p ( {r}_{c} \vert {r}_{e} )\end{matrix} \qquad Eq . 7$$

It is noted that p(c₁|e₁) and p(c₂|e₂) are translation probabilities within triples; and thus, they are not unrestricted probabilities. Below, the translation between head p(c₁|e₁) and dependant p(c₂|e₂) are expressed as p_{head}(c|e) and p_{dcp}(c|e), respectively. The probability values p_{head}(c₁|e₁) and p_{dep}(C₂|e₂) cannot be estimated directly due to lack of or insufficient aligned corpora. The present approach includes estimating the word translation probabilities or values p_{head}(c₁|e₁) and p_{dep}(c₂|e₂) with monolingual corpora, typically of source and target languages. These word translation probabilities p_{head}(c₁|e₁) and p_{dep}(c₂|e₂) are constituent probabilities of the collocation translation model.

As the correspondence between the same dependency relation across English and Chinese is strong, for convenience, it can be assumed that p(r_{c}|rₑ)=1for the corresponding rₑ and r_{c}, and p(r_{c}|rₑ)=0 for the other cases. In other embodiments p(r_{c}|rₑ) ranges from 0.8 and 1.0 and p(r_{c}|rₑ) correspondingly ranges from 0.2 to 0.0. The relational probability value p(r_{c}|rₑ) is another constituent probability value of the collocation translation model and can be estimated by known means. In many embodiments values of p(r_{c}|rₑ) are a function of the particular dependency relation.

### Broad Aspects of the Present Approach

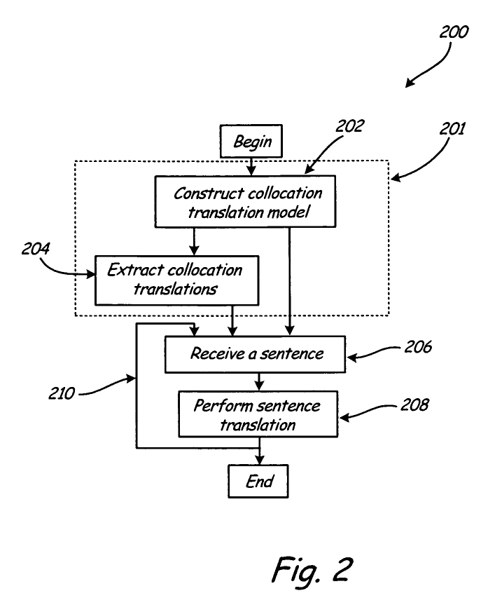

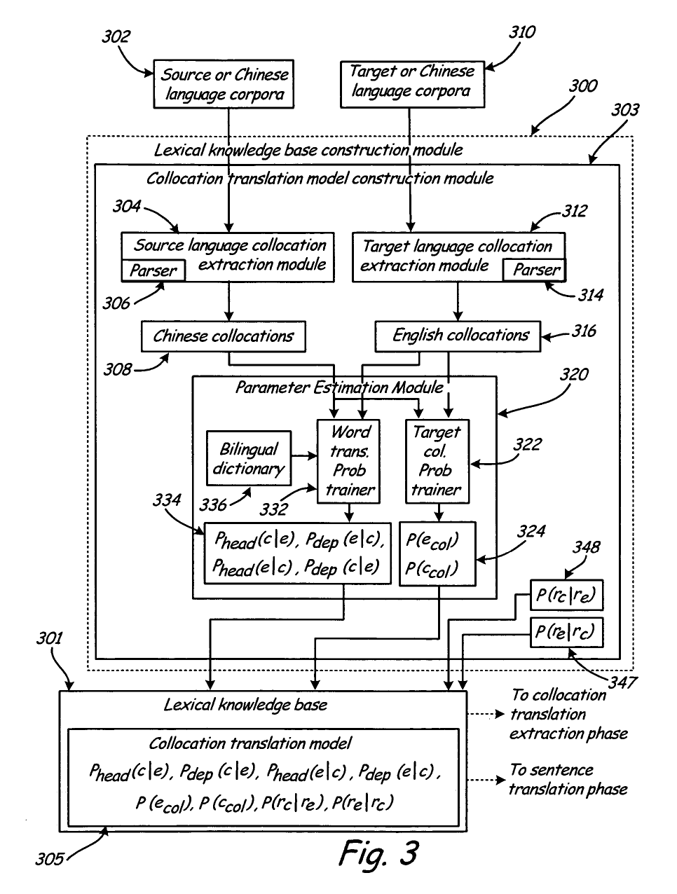

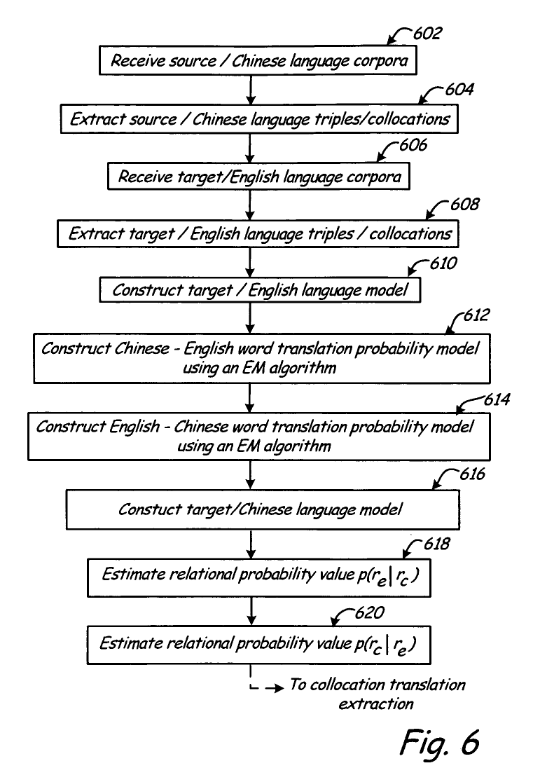

FIG. 2 is an overview flow diagram showing broad aspects of the present approach embodied as a single method 200. FIGS. 3, 4 and 5 are block diagrams illustrating modules for performing each of the aspects. FIGS. 6, 7, and 8 illustrate methods generally corresponding with the block diagrams illustrated in FIGS. 3, 4, and 5. It should be understood that the block diagrams, flowcharts, methods described herein are illustrative for purposes of understanding and should not be considered limiting. For instance, modules or steps can be combined, separated, or omitted in furtherance of practicing aspects of the present invention.

Referring now to FIG. 2, step 201 of method 200 includes augmenting a lexical knowledge base with information used later for further natural language processing, in particular, text or sentence translation. Step 201 comprises step 202 of constructing a collocation translation model (or at least some of the constituent probability values of the collocation translation model) in accordance with the present approach. Step 201 further comprises step 204 of using the collocation translation model of the present approach to extract and/or acquire collocation translations. In many embodiments, some or all of the extracted collocation translations are compiled in a collocation translation dictionary comprising a list of source language collocations and one or more corresponding target language collocation translations.

Method 200 further comprises step 208 of using both the constructed collocation translation model (or some constituent probability values) and the extracted collocation translations or collocation translation dictionary to perform sentence translation of a received sentence as indicated at 206. Sentence translating can be iterative as indicated at 210.

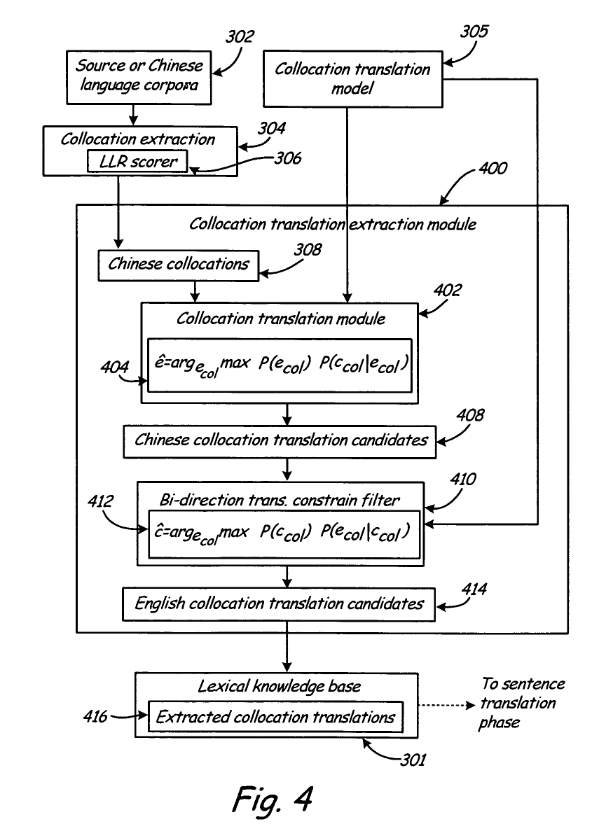

FIG. 3 illustrates a block diagram of a system comprising lexical knowledge base construction module 300. FIG. 6 is a flow diagram illustrating augmentation of lexical knowledge base 301 and corresponds generally with FIG. 3. Lexical knowledge base construction module 300 comprises collocation translation model construction module 303, which constructs collocation translation model 305. Collocation translation model 305 augments lexical knowledge base 301, which is used later in performing collocation translation extraction and sentence translation, such as illustrated in FIGS. 4-5, and 7-8.

Lexical knowledge base construction module 300 can be an application program 135 executed on computer 110 or stored and executed on any of the remote computers in the LAN 171 or the WAN 173 connections. Likewise, lexical knowledge base 301 can reside on computer 110 in any of the local storage devices, such as hard disk drive 141, or on an optical CD, or remotely in the LAN 171 or the WAN 173 memory devices.

At step 602, source or Chinese language corpus or corpora 302 are received by collocation translation model construction module 303. Chinese has been referred to, illustratively, but it is noted that source language corpora 302 can comprise text in any natural language. In most embodiments, source language corpora 302 comprises unprocessed or pre-processed data or text, such as text obtained from newspapers, books, publications and journals, web sources, speech-to-text engines, and the like. Source language corpora 302 can be received from any of the input devices described above as well as from any of the data storage devices described above.

At step 604, source language collocation extraction module 304 parses Chinese language corpora 302 into dependency triples using parser 306 to generate Chinese collocations or collocation database 308. In many embodiments, collocation extraction module 304 generates source language or Chinese collocations 308 using, for example, a scoring system based on the Log Likelihood Ratio (LLR) metric, which can be used to extract collocations from dependency triples. Such LLR scoring is described in “Accurate methods for the statistics of surprise and coincidence,” by Ted Dunning, Computational Linguistics, 10(1), pp. 61-74 (1993). In other embodiments, source language collocation extraction module 304 generates a larger set of dependency triples. In other embodiments, other methods of extracting collocations from dependency triples can be used, such as a method based on weighted mutual information (WMI).

At step 606, collocation translation model construction module 303 receives target or English language corpus or corpora 310 from any of the input devices described above as well as from any of the data storage devices described above. It is also noted that use of English is illustrative only and that other target languages can be used.

At step 608, target language collocation extraction module 312 parses English corpora 310 into dependency triples using parser 314. As above with module 304, collocation extraction module 312 can generate target or English collocations 316 using any method of extracting collocations from dependency triples. In other embodiments, collocation extraction 312 module can generate dependency triples without further filtering. English collocations or dependency triples 316 can be stored in a database for further processing.

At step 610, parameter estimation module 320 receives English collocations 316 and estimates language model p(e_{col}) 324 with target or English collocation probability trainer 322 using any known method of estimating collocation language models. As described above, target collocation probability trainer 322 can estimate probability values 324 based on the count of each collocation and the total number of collocations in target language corpora 310. Optional smoothing can be used to mitigate problems associated with data sparseness, such as using Equations 4 and 5.

In many embodiments, trainer 322 estimates only selected types of collocations, particularly based on type of dependency relation. As described above, verb-object, noun-adjective, and verb-adverb collocations have particularly high correspondence in the Chinese-English language pair. For this reason, embodiments of the present inventions can limit the types of collocations trained to those that have high relational correspondence.

At step 612, parameter estimation module 320 receives or accesses Chinese collocations 308, English collocations 316, and bilingual dictionary 336 (e.g. Chinese-to-English) and estimates word translation probabilities 334 using word translation probability trainer 332. To do so, a candidate English translation set of Chinese triples is generated with bilingual dictionary 336 and the assumption of strong correspondence of dependency relations. It is noted that there is a risk that unrelated triples in Chinese and English can be connected with this method. However, since the conditions used to make the connection are quite strong (i.e. possible word translations in the same triple structure), it is believed that the risk is not great. Then, an expectation maximization (EM) algorithm is introduced to iteratively strengthen the correct connections and weaken the incorrect connections.

According to Equation 1 above, the translation probabilities from a Chinese triple cₜᵣᵢ to an English triple eₜᵣᵢ or p(eₜᵣᵢ|cₜᵣᵢ) can be calculated using an English triple language model p(eₜᵣᵢ) and a translation model from English to Chinese or p(cₜᵣᵢ|eₜᵣᵢ). As above, the English language model can be estimated using Equation (4) and the translation model can be calculated using Equation (7). The word translation probabilities p_{head}(c|e) and p_{dep}(c|e) can be initially set to a uniform distribution as follows:

$${p}_{head} ( c \vert e ) = {p}_{dep} ( c \vert e ) = \{ \begin{matrix}\frac{1}{\vert {Γ}_{e} \vert} , & if ( c ∈ {Γ}_{e} ) \\ 0 , & otherwise\end{matrix} \qquad Eq . 8$$

where Γₑ represents the translation set of the English word e.

### The EM Algorithm

The word translation probabilities are then estimated iteratively using an EM algorithm as follows:

$$E \text{-} step \text{:} p ( {e}_{tri} \vert {c}_{tri} ) ← \frac{p ( {e}_{tri} ) {p}_{head} ( {c}_{1} \vert {e}_{1} ) {p}_{dep} ( {c}_{2} \vert {e}_{2} ) p ( {r}_{c} \vert {r}_{e} )}{{\sum }_{{e}_{tri} = ( {e}_{1} , {r}_{e ,} {e}_{2} ) ∈ ETri}^{} p ( {e}_{tri} ) {p}_{head} ( {c}_{1} \vert {e}_{1} ) {p}_{dep} ( {c}_{2} \vert {e}_{2} ) p ( {r}_{c} \vert {r}_{e} )}$$

$$\begin{matrix}M \text{-} step \text{:} {p}_{head} ( c \vert e ) = \frac{{\sum }_{{e}_{tri} = ( e , * , *)}^{} {\sum }_{{c}_{tri} = ( c , * , *)}^{} p ( {c}_{tri} ) p ( {e}_{tri} \vert {c}_{tri} )}{{\sum }_{{e}_{tri} = ( e , * , *)}^{} {\sum }_{{c}_{tri} ∈ CTri}^{} p ( {c}_{tri} ) p ( {e}_{tri} \vert {c}_{tri} )} \\ {p}_{dep} ( c \vert e ) = \frac{{\sum }_{{e}_{tri} = (* , * , e )}^{} {\sum }_{{c}_{tri} = (* , * , c )}^{} p ( {c}_{tri} ) p ( {e}_{tri} \vert {c}_{tri} )}{{\sum }_{{e}_{tri} = (* , * , e )}^{} {\sum }_{{c}_{tri} ∈ CTri}^{} p ( {c}_{tri} ) p ( {e}_{tri} \vert {c}_{tri} )}\end{matrix}$$

where, ETri represents English triple set and CTri represents Chinese triple set. Table 1 below provides a further description of the EM algorithm.

TABLE 1
EM algorithm

```
Train language model for English triple p(eₜᵣᵢ);
Initialize word translation probabilities
  p_{head}(c | e) and p_{dep} uniformly as in Equation (8);
Iterate
  Set score_{head}(c | e) andscore_{dep}(c | e) to 0 for all
    dictionary entries (c,e);
    for all Chinese triples cₜᵣᵢ = (c₁,r_{c},c₂)
        for all candidate English triple
      translations eₜᵣᵢ = (e₁,rₑ,e₂)
        compute triple translation probability
        p(eₜᵣᵢ | cₜᵣᵢ)by
        p(eₜᵣᵢ)p_{head}(c₁ | e₁)p_{dep}(c₂ | e₂)p(r_{c} | rₑ)
      endfor
      normalize p(eₜᵣᵢ | cₜᵣᵢ), so that their sum is 1;
      for all triple translation eₜᵣᵢ = (e₁,rₑ,e₂)
          add p(eₜᵣᵢ | cₜᵣᵢ) to score_{head}(c₁ | e₁)
          add p(eₜᵣᵢ | cₜᵣᵢ) to score_{dep}(c₂ | e₂)
        endfor
      endfor
      for all translation pairs (c,e)
        set p_{head}(c | e) to normalized score_{head}(c | e);
        set p_{dep}(c | e) to normalized score_{dep}(c | e);
      endfor
enditerate
```

The basic idea is that under the restriction of the English triple language model p(eₜᵣᵢ) and bilingual dictionary, the translation probabilities p_{head}(c|e) and p_{dcp}(c|e) can be estimated that best explains the Chinese triple database as a translation from the English triple. With each iteration, the normalized triple translation probabilities are used to update the word translation probabilities. Generally, since the English triple language model provides context information for the disambiguation of the Chinese words, only the appropriate occurrences are counted.

With the language model estimated such as with Equation (4) and the translation probabilities estimated using EM algorithm, the best English triple translation for a given Chinese triple can be computed, in most embodiments, using Equations (1) and (7).

At step 614, the original source and target languages are reversed so, for example, English is considered the source language and Chinese is the target language. Parameter estimation module 320 receives the reversed source and target language collocations and estimates an English-Chinese word translation probability model with the aid of an English-Chinese dictionary 336. Such probability values p_{head}(e|c) and p_{dep}(e|c) can be used later for bi-directional filtering for more accurate collocation translation extraction as described below. At step 616, parameter estimation module 320 comprising target collocation probability trainer 322 constructs language model p(c_{col}) 324 in the same manner described above also, which can also be used in bi-directional filtering.

At step 618, a relational translation score or probability p(rₑ|r_{c}) indicated at 347 is estimated. Generally, it can be assumed that there is a strong correspondence between the same dependency relation in Chinese and English. Therefore, in most embodiments it is assumed that p(rₑ|r_{c})=1 if rₑ corresponds with rₑ, otherwise, p(rₑ|r_{c})=0. However, in other embodiments, the values of p(rₑ|r_{c}) can range from 0.8 to 1.0 if rₑ corresponds with rₑ, otherwise, 0.2 to 0, respectively, as discussed above.

At step 620, values of p(r_{c}|rₑ) indicated at 348 are estimated assuming that Chinese and English as source and target languages have been switched. Values of p(r_{c}|rₑ) can also be used for bi-directional filtering.

After all parameters are estimated, collocation translation model 305 can be used for collocation translation. It can also be used for collocation translation extraction or dictionary acquisition.

### Collocation Translation Extraction

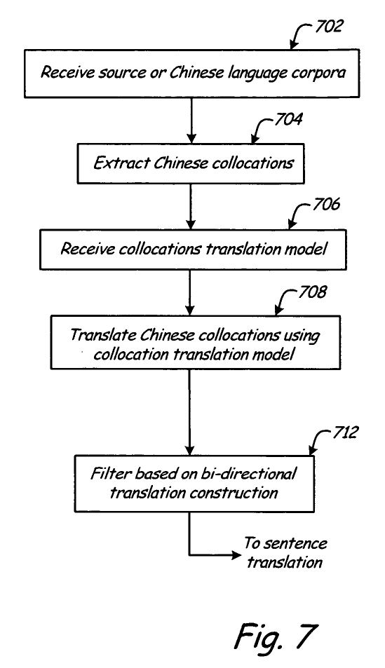

Referring now to FIGS. 2, 4, and 7, FIG. 4 illustrates a system, which performs step 204 of extracting collocation translations to further augment lexical knowledge base 301 with a collocation translations or collocation translation dictionary 416 of a particular source and target language pair. FIG. 7 corresponds generally with FIG. 4 and illustrates using lexical collocation translation model 305 to extract and/or acquire collocation translations.

At step 702, collocation extraction module 304 receives source language corpora 302. At step 704, collocation extraction module 304 extracts source language collocations 308 from source language corpora 302 using any known method of extracting collocations from natural language text. In many embodiments, collocation extraction module 304 comprises Log Likelihood Ratio (LLR) scorer 306. LLR scorer 306 scores dependency triples cₜᵣᵢ=(c₁,r_{c},c₂) to identify source language collocations c_{col}=(c₁,r_{c},c₂) indicated at 308. In many embodiments, Log Likelihood Ratio (LLR) scorer 306 calculates LLR scores as follows:

$$\begin{matrix}Log l = a log a + b log b + c log c + d log d - \\ ( a + b ) log ( a + b ) - ( a + c ) log ( a + c ) - \\ ( b + d ) log ( b + d ) - ( c + d ) log ( c + d ) + N log N\end{matrix}$$

where, N is the total counts of all Chinese triples, and
a=f(c₁,r_{c},c₂),
b=f(c₁,r_{c},*)−f(c₁,r_{c},c₂),
c=f(*,r_{c},c₂)−f(c₁,r_{c},c₂),
d=N−a−b−c.
It is noted that f indicates counts or frequency of a particular triple and * is a “wildcard” indicating any Chinese word. Those dependency triples whose frequency and LLR values are larger than selected thresholds are identified and taken as source language collocation 308.

As described above, in many embodiments, only certain types of collocations are extracted depending on the source and target language pair being processed. For example, verb-object (VO), noun-adjective (AN), verb-adverb (AV) collocations can be extracted for the Chinese-English language pair. In one embodiment, the subject-verb (SV) collocation is also added. An important consideration in selecting a particular type of collocation is strong correspondence between the source language and one or more target languages. It is further noted that LLR scoring is only one method of determining collocations and is not intended to be limiting. Any known method for identifying collocations from among dependency triples can also be used (e.g. weighted mutual information (WMI).

At step 706, collocation translation extraction module 400 receives collocation translation model 305, which comprises at least constituent probability values p_{head}(c|e), p_{dep}(c|e), p(e_{ccol}), and p(r_{c}|rₑ). In other embodiments, collocation translation model 305 further comprises probability values p_{head}(e|c), p_{dep}(e|c), p(c_{col}), and p(rₑ|r_{c}), as described above.

At step 708, collocation translation module 402 translates Chinese collocations 308 into target or English language collocations 408 using probability information in collocation translation model 305. Each Chinese collocation c_{col} among Chinese collocations 308 are translated into the most probable English collocation ê_{col} as indicated at 404 and below:

$${\hat{e}}_{col} = {arg max}_{{e}_{col }} p ( {e}_{col} ) p ( {c}_{col} \vert {e}_{col} )$$

In many embodiments, collocation translations are considered collocation translation candidates 408. Further filtering is performed to ensure that only highly reliable collocation translations are extracted. To this end, collocation translation extraction module 400 can include filters such as bi-directional translation constrain filter 410.

At step 712, bi-directional translation constrain filter 410 filters translation candidates 408 to generate extracted collocation translations or dictionary 416 that can be used later during further language processing. Step 712 includes extracting English collocation translation candidates 414 with English-Chinese collocation translation model 305. Such an English-Chinese translation model 305 can be constructed, such as at step 614 (illustrated in FIG. 6) where Chinese is considered the target language and English considered the source language. At step 712, English collocations 308 can be translated into the most probable collocation translation ĉ_{col} as indicated at 412 and below:

$${\hat{c}}_{col} = {arg max}_{{c}_{col }} p ( {c}_{col} ) p ( {e}_{col} \vert {c}_{col} )$$

For greater dictionary accuracy, those collocation translations that appear in both translation candidate sets 408, 414 are extracted as final collocation translations 416. Thus, in many embodiments, the best English triple candidate is extracted as the translation of the given Chinese collocation only if the Chinese collocation is also the best translation candidate of the English triple.

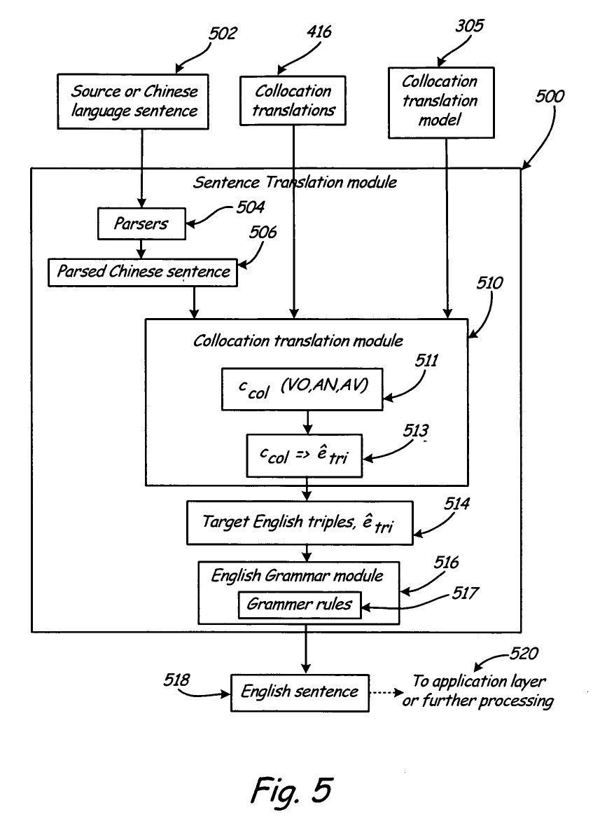

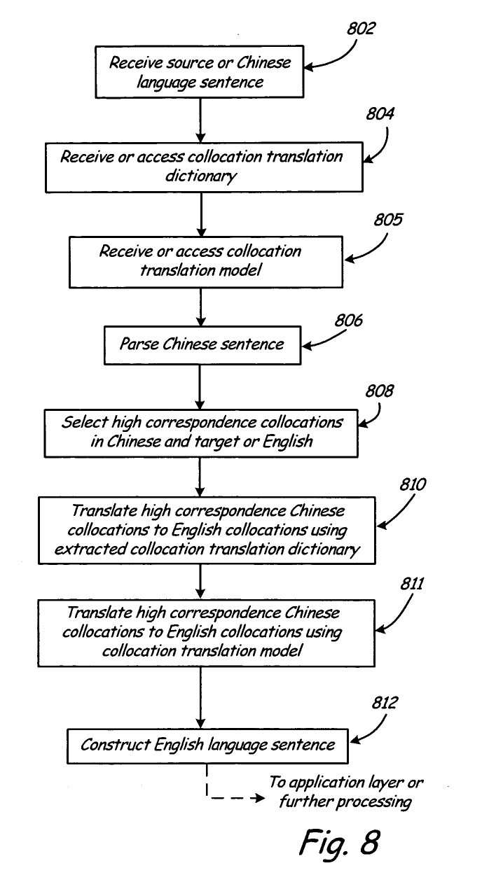

FIG. 5 is a block diagram of a system for performing sentence translation using the collocation translation dictionary and collocation translation model constructed in accordance with the present inventions. FIG. 8 corresponds generally with FIG. 5 and illustrates sentence translation using the collocation translation dictionary and collocation translation model of the present inventions.

At step 802, sentence translation module 500 receives source or Chinese language sentence through any of the input devices or storage devices described with respect to FIG. 1. At step 804, sentence translation module 500 receives or accesses collocation translation dictionary 416. At step 805, sentence translation module 500 receives or accesses collocation translation model 305. At step 806, parser(s) 504, which comprises at least a dependency parser, parses source language sentence 502 into parsed Chinese sentence 506.

At step 808, collocation translation module 500 selects source or Chinese language collocations based on types of collocations having high correspondence between Chinese and the target or English language. In some embodiments, such types of collocations comprise verb-object, noun-adjective, and verb-adverb collocations as indicated at 511.

At step 810, collocation translation module 500 uses collocation translation dictionary 416 to translate Chinese collocations 511 to target or English language collocations 514 as indicated at block 513. At step 810, for those collocations of 511 that can not find translations using collocation translation dictionary, collocation translation module 500 uses collocation translation model 305 to translate these Chinese collocations to target or English language collocations 514. At step 812, English grammar module 516 receives English collocations 514 and constructs English sentence 518 based on appropriate English grammar rules 517. English sentence 518 can then be returned to an application layer or further processed as indicated at 520.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer readable medium including instructions readable by a computer which, when implemented, cause the computer to construct a collocation translation model comprising the steps of:
extracting source language collocations from monolingual source language corpora;
extracting target language collocations from monolingual target language corpora; and
constructing a collocation translation model using at least the source and target language collocations.

2. The computer readable medium of claim 1, wherein the collocation translation model is estimated using an expectation maximization algorithm.

3. The computer readable medium of claim 2, wherein the collocation translation model comprises translation probabilities between individual words in the source language collocations and individual words in the target language collocations.

4. The computer readable medium of claim 1, and further comprising constructing a target language model using the extracted target language collocations.

5. The computer readable medium of claim 3, and further comprising:
receiving a bilingual dictionary; and
estimating word translation probabilities of corresponding words in the source and target language collocations using the bilingual dictionary and the target language model.

6. The computer readable medium of claim 1, and further comprising selecting dependency relation types of collocations based on correspondence between the source and target language pair.

7. The computer readable medium of claim 6, and further comprising estimating relational probability values for the selected dependency relation types of collocations.

8. The computer readable medium of claim 6, wherein the dependency relation types selected comprise at least some of subject-verb, verb-object, noun-adjective, and verb-adverb types of collocations.

9. A method of extracting collocation translations comprising the steps of:
parsing source language corpora into dependency triples;
parsing target language corpora into dependency triples;
estimating word translation probabilities between at least some of corresponding words in the source language dependency triples and target language dependency triples; and
extracting a collocation translation dictionary based in part on the estimated word translation probabilities.

10. The method of claim 9, and further comprising:
selecting source language collocations from among the source language dependency triples; and
selecting target language collocations from among the target language dependency triples.

11. The method of claim 9, wherein estimating word translation probabilities comprises using an expectation maximization algorithm to iteratively estimate the word translation probabilities.

12. The method of claim 11, wherein estimating word translation probabilities comprises accessing a bilingual dictionary and collocation language model of the target language.

13. The method of claim 10, and further comprising estimating probabilities for at least some of the target language collocations.

14. The method of claim 10, and further comprising estimating dependency relation probabilities for at some types of collocations based on correspondence between the source and target languages.

15. The method of claim 10, wherein extracting a collocation translation dictionary comprises identifying a set of collocation translation candidates in the target language based at least in part on the estimated word translation probabilities.

16. The method of claim 15, wherein extracting a collocation translation dictionary comprises:
using a bi-directional translation constrain filter to generate a set of collocation translation candidates in the source language; and
selecting collocation translations comprising collocations in the sets of collocation translation candidates in the source and target languages.

17. A system of extracting collocation translations comprising:
a first module adapted to construct a collocation translation model from monolingual source and target language corpora; and
a second module adapted to access the collocation translation model and extract a collocation translation dictionary based on the collocation translation model.

18. The system of claim 17, and further comprising:
a third module adapted to receive a source language sentence and access the collocation translation dictionary to translate the received source language sentence to a target language sentence, wherein the first module constructs the collocation translation model by estimating word translation probabilities using an expectation maximization algorithm.

19. The system of claim 18, wherein the third module comprises a grammar module comprising grammar rules of the target language, wherein the grammar rules are used to construct the target language sentence.

20. The system of claim 17, wherein the second module is adapted to filter collocation translation candidates based on bi-directional constraints to generate the collocation translation dictionary.
